(19) United States
(12) Patent Application Publication
(10) Pub. No.: US 2024/0238671 A1
(43) Pub. Date: Jul. 18, 2024

(54) PROGRAM, INFORMATION PROCESSING DEVICE, METHOD, AND SYSTEM

(71) Applicant: CYGAMES, INC., Tokyo (JP)

(72) Inventors: Kotaro Oki, Tokyo (JP); Junji Tago, Tokyo (JP); Yuta Kunibe, Tokyo (JP)

(73) Assignee: CYGAMES, INC., Tokyo (JP)

(21) Appl. No.: 18/618,685

(22) Filed: Mar. 27, 2024

Related U.S. Application Data
(63) Continuation of application No. PCT/JP2022/036539, filed on Sep. 29, 2022.

(30) Foreign Application Priority Data
Sep. 30, 2021 (JP) 2021-161067

(51) Int. Cl. A63F 13/42; A63F 13/87

(52) U.S. Cl. CPC A63F 13/42; A63F 13/87

(57) ABSTRACT

Provided are a program, an information processing device, a method, and a system allowing players to casually interact with each other.

A game system 1 is a system for a game, said system having a plurality of information processing devices 10, and at least one of the information processing devices 10 includes a communication action control unit 40 that decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

### TECHNICAL FIELD

The present invention relates to programs, etc. and particularly to a program, etc. related to a multi-player game.

### BACKGROUND ART

There are well-known multi-player games that allow a plurality of players to simultaneously enjoy a game in the same game space by realizing data communication among a plurality of game devices.

### CITATION LIST

### Patent Literature

### [PTL 1]

Publication of Japanese Patent No. 5349860

### SUMMARY OF INVENTION

### Technical Problem

In multi-player games, text information, gestures, stamps, etc. are known as means for communicating with other players. In order to have communication with other players by these means, a player himself/herself needs not only to determine the game situation but also to select one of a plurality of predetermined items of text information, gestures, and stamps, and hence it is difficult for the player to casually interact with other players. Thus, conventional multi-player games have room for improvement to assist, for example, game beginners and players feeling reluctant to have communication in casually having communication.

The present invention has been conceived in order to solve these problems, and one of the objects of the present invention is to provide a program, an information processing device, a method, and a system that allow a player to casually interact with other players.

### Solution to Problem

A program according to an aspect of the present invention is a program for a game executed on an information processing device and causes the information processing device to function as communication action control means for deciding a communication action among a plurality of communication actions according to a game situation in response to an action-invoking input made by a player and causing a game medium associated with the player to execute the decided communication action, wherein the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

An information processing device according to an aspect of the present invention is an information processing device for executing a game and includes communication action control means for deciding a communication action among a plurality of communication actions according to a game situation in response to an action-invoking input made by a player and causing a game medium associated with the player to execute the decided communication action, wherein the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

A method according to an aspect of the present invention is a method for a game and includes a communication action control step for deciding a communication action among a plurality of communication actions according to a game situation in response to an action-invoking input made by a player and causing a game medium associated with the player to execute the decided communication action, wherein, in the communication action control step, a first communication action is decided on the basis of a game situation of a first game medium associated with a first player in response to an action-invoking input made by the first player, the first game medium is made to execute the first communication action, a second communication action is decided in response to an action-invoking input made by a second player after the execution of the first communication action, and a second game medium associated with the second player is made to execute the second communication action.

A system according to an aspect of the present invention is a system for a game and has a plurality of information processing devices, wherein at least one of the information processing devices includes communication action control means for deciding a communication action among a plurality of communication actions according to a game situation in response to an action-invoking input made by a player and causing a game medium associated with the player to execute the decided communication action, the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

### Advantageous Effects of Invention

The present invention allows players to casually interact with one another.

### BRIEF DESCRIPTION OF DRAWINGS

FIG. 1 is a drawing showing an example of the overall configuration of a game system according to an embodiment of the present invention.

FIG. 2 is a block diagram showing the hardware configuration of an information processing device according to an embodiment of the present invention.

FIG. 3 is an example of a functional block diagram of the information processing device according to an embodiment of the present invention.

FIG. 4 is an example of a functional block diagram of a game control unit.

FIG. 5 is an example of a functional block diagram of a communication action control unit.

FIG. 6 is an example of a correspondence table between game situation categories and communication actions.

FIG. 7 is an example of a game screen showing an action selection made by a player.

FIG. 8 is an example of a game screen showing execution of a first communication action.

FIG. 9 is an example of a game screen showing execution of a second communication action.

FIG. 10 is an example of a game screen displayed in highlights by a display control unit.

FIG. 11 is an example of an operation flowchart for the game system according to an embodiment of the present invention.

### DESCRIPTION OF EMBODIMENTS

A game system according to an embodiment of the present invention will now be described with reference to the drawings. In this description, there are cases where descriptions that are more detailed than necessary are omitted for convenience of description. For example, there are cases where detailed descriptions of matters that are already well known and repeated descriptions of substantially the same configurations are omitted.

This game system can be realized by a system in which a plurality of information processing devices are connected via a network but can also be realized by a single information processing device. First, an embodiment realized by a system connected to a network is described, followed by a description of a single information processing device.

### [Embodiment Realized by System]

### [Schematic Configuration]

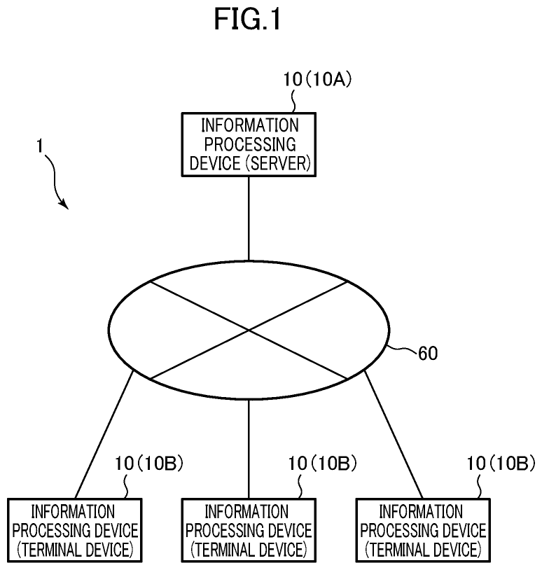

FIG. 1 is a drawing showing an example of the overall configuration of a game system 1 according to an embodiment of the present invention. As shown in FIG. 1, the game system 1 includes a plurality of information processing devices 10. The information processing devices 10 include a server and a terminal device used by each player. That is, in the case where an information processing device 10 is a server, it is also referred to as a server 10A, and in the case where an information processing device 10 is a terminal device, it is also referred to as a terminal device 10B. Thus, one aspect of an information processing device 10 is the server 10A, and another aspect of the information processing device 10 is the terminal device 10B. The server 10A and the terminal device 10B can include the hardware configuration of an information processing device 10 and are connected to a network 60, such as the Internet, so as to be capable of communicating with each other. Note that although the game system 1 according to this embodiment will be described assuming a server-client system, the game system 1 can also be configured from a system without the server 10A, such as a PtoP system.

The server 10A can be configured from at least one computer that provides a game reproducible in the terminal device 10B. The terminal device 10B is a game device for consumers in this embodiment. It should be noted, however, that the terminal device 10B can be a computer, such as a smartphone, a tablet computer, a notebook personal computer, or a desktop computer, as long as the terminal device 10B includes the hardware configuration of the information processing device 10.

The server 10A stores various programs, such as a control program for controlling the progress of an online game, and various kinds of data used in the game. The server 10A transmits/receives data to/from the terminal device 10B periodically or as needed to proceed with the game.

In an example, the terminal device 10B pre-stores a game application program executable therein, accepts a game-related operation, and transmits information concerning the operation to the server 10A. The server 10A executes a game, transmits, to the terminal device 10B, the execution result and information necessary for display on the terminal device 10B, and displays information concerning the game on the screen of an output device of the terminal device 10B. Note that although the terminal device 10B according to this embodiment is a game device for consumers, in the case where the terminal device 10B is a smartphone, the terminal device 10B can acquire the game application program by downloading it from the server 10A.

### [Detailed Configuration]

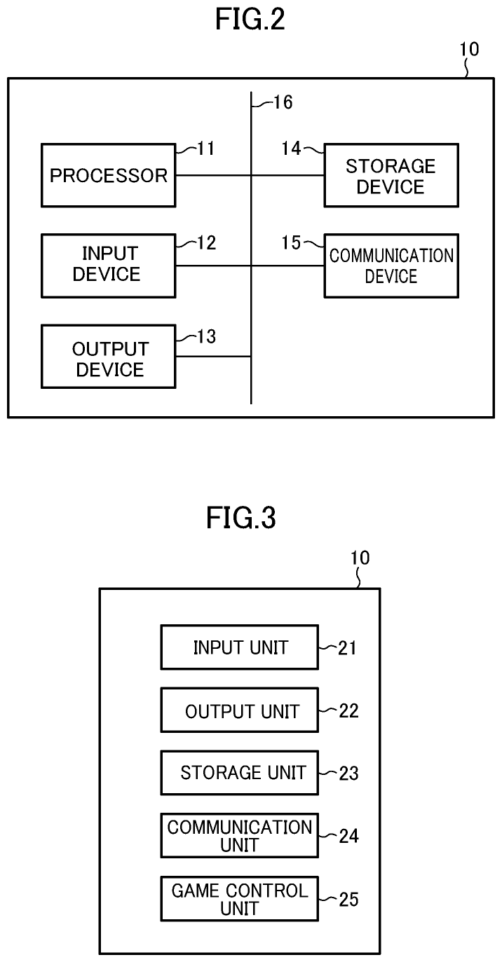

FIG. 2 is a block diagram showing the hardware configuration of the information processing device 10. As shown in FIG. 2, the information processing device 10 includes a processor 11, an input device 12, an output device 13, a storage device 14, and a communication device 15. The configurations 11 to 15 are connected via a bus 16. Note that an interface may be disposed, as needed, between the bus 16 and each of the configurations 11 to 15.

The processor 11 controls the overall operation of the information processing device 10 and is, for example, an electronic circuit, such as a CPU or an MPU. The processor 11 executes various kinds of processing by reading programs and data stored in the storage device 14 and then executing the programs. In an example, the processor 11 is configured from a plurality of processors.

The input device 12 is a user interface for accepting inputs from a user (player) to the information processing device 10. The input device 12 is, for example, a touch panel, a touch pad, a keyboard, a mouse, a microphone, or a game controller having physical buttons. In the case where the information processing device 10 is provided with a touch panel, this touch panel can be realized by, for example, a touchscreen, which functions as both the input device 12 and the output device 13. The input device 12 and the output device 13 may have separate forms disposed at different positions.

The output device 13 presents the user of the information processing device 10, i.e., the player, with application screens, etc. under the control of the processor 11. The output device 13 can include a display device, such as a liquid crystal display, an organic EL display, and a plasma display, and an acoustic device, such as a speaker issuing sound.

The storage device 14 includes a main memory, a buffer memory, and a storage and is a storage device provided in a general smartphone or computer, typified by a storage device using a RAM (volatile memory) or a flash memory (nonvolatile memory), such as an eMMC, a UFS, and an SSD, as well as a magnetic storage device. The storage device 14 can include external memories. The storage device 14 stores, for example, a game application. The game application includes a game program for executing a game and various kinds of data that are referenced when the game program is executed. The game program is started in response to a user operation on the information processing device 10 and is executed on the operating system (OS) pre-installed in the information processing device 10.

In an example, the storage device 14 includes a main storage device and an auxiliary storage device. The main storage device is a volatile storage medium that allows high-speed reading and writing of information, and is used as a storage area and a work area when the processor 11 processes information. The auxiliary storage device stores various programs and data that are used by the programs when the individual programs are executed. The auxiliary storage device is, for example, an SSD or a hard disk device; however, the auxiliary storage device may be any type of nonvolatile storage or nonvolatile memory, which may be of the removable type, that is capable of storing information. For example, the auxiliary storage device stores the operating system (OS), middleware, application programs, various kinds of data that may be referenced when these programs are executed, etc.

The communication device 15 transmits/receives data to/from other computers, such as the server, via the network 60. For example, the communication device 15 performs wireless communication, such as mobile communication or wireless LAN communication, to connect to the network 60. In an example, the information processing device 10 downloads a program from the server by means of the communication device 15 and stores the program in the storage device 14. Alternatively, the communication device 15 may perform wired communication by using, for example, an Ethernet® cable. In the case where data is neither transmitted to nor received from other computers, the information processing device 10 does not need to include the communication device 15.

FIG. 3 is an example of a functional block diagram of the information processing device 10. The information processing device 10 includes an input unit 21, an output unit 22, a storage unit 23, a communication unit 24, and a game control unit 25. In this embodiment, these functions are realized by the processor 11 executing programs. For example, programs executed are game programs that are stored in the storage device 14 or received via the communication device 15. Since various kinds of functions are realized by reading programs, as described above, a portion or the entirety of one part (function) may be provided in another part. Various kinds of functions are realized as respective means by executing programs. These functions may be realized by means of hardware by configuring electronic circuits or the like for realizing the individual functions in part or in entirety.

The input unit 21 is configured using the input device 12 and accepts inputs to the information processing device 10 from the user. The output unit 22 is configured using the output device 13 and provides information concerning the game to present the information to the user of the information processing device 10. The storage unit 23 is configured using the storage device 14 and stores information concerning various kinds of games and programs. The communication unit 24 is configured using the communication device 15 and functions as an interface for transmitting/receiving information to/from another information processing device 10. The communication unit 24 transmits, to other information processing devices 10 via the network 60, input information that comes from the user and that is accepted by the input unit 21. Also, the communication unit 24 receives information from other information processing devices 10 and transmits that information to each unit.

The game control unit 25 performs basic control in executing the game according to this embodiment. The game control unit 25 is configured to include the processor 11, executes the game, and causes the output device 13 to display screens related to the game. The execution of the game by means of the game control unit 25 can include: acquiring, from the storage device 14, information necessary for the execution; acquiring information concerning player operations via the input device 12, the communication device 15, and/or the network 60; executing information processing of the game on the basis of the necessary information; and generating and/or acquiring information necessary to display a screen to be displayed on the output device 13 on the basis of the information processing.

The server 10A may be provided with all functions of the game control unit 25. Alternatively, the server 10A may be provided with a portion of the game control unit 25, and the terminal device 10B may be provided with the other portion of the game control unit 25. In addition, each terminal device 10B may be provided with all functions of the game control unit 25, with the server 10A having no functions of the game control unit 25. Alternatively, portions of the game control unit 25 may be distributed over respective terminal devices 10B so that the terminal devices 10B as a whole cover the functions of the game control unit 25. In this embodiment, it is assumed that the server 10A is provided with the game control unit 25, and each terminal device 10B is not provided with the game control unit 25.

The game according to this embodiment is a multi-player game in which data communication is performed among a plurality of information processing devices 10, so that a plurality of players can enjoy the game simultaneously in the same game field. In an example, a plurality of players can jointly play this multi-player game, for example, such that game media (player characters) operated by the respective players defeat an enemy in the game field. In another example, players realize communication therebetween by the game media associated with the respective players performing communication actions while the game is in progress.

The game control unit 25 sets the game field as a virtual space for the progress of the game, and displays a portion of the game field as a game screen on the output device 13 of each terminal device 10B. Player characters and an enemy character are placed in the game field. A player character is a game medium associated with a player and is an object that behaves in the game field on the basis of the player input via the input device 12. An enemy character is a game medium (non-player object) that behaves in the game field independently of the player input. In an example, player characters cooperate with each other in the game field to fight a battle against the enemy character.

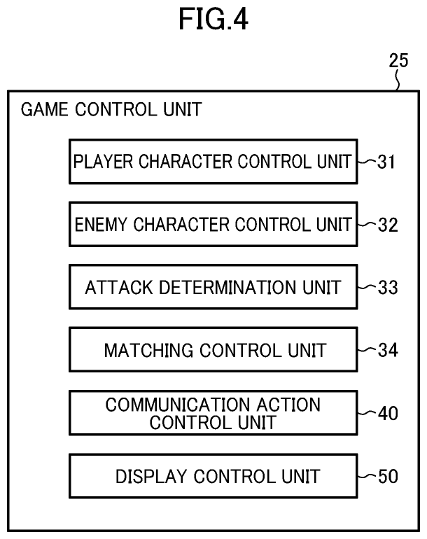

FIG. 4 is an example of a functional block diagram of the game control unit 25. The game control unit 25 includes a player character control unit 31, an enemy character control unit 32, an attack determination unit 33, a matching control unit 34, a communication action control unit 40, and a display control unit 50.

The player character control unit 31 controls the player character on the basis of the player input via the input device 12. The player character executes actions such as a transfer, a spin, an attack, an escape, defense, eating, etc. Note that the player input here is different from an action-invoking input described below.

The enemy character control unit 32 controls the enemy character on the basis of a predetermined behavior pattern independently of the player input. The predetermined behavior pattern is a predecided behavior pattern of, for example, a transfer, a spin, an attack, a transfer, a transfer, and an attack. The enemy character's behaviors are carried out in this order. A plurality of behavior patterns may be set in advance so that the enemy character control unit 32 can select one of them on the basis of a game state.

The attack determination unit 33 determines whether or not an attack launched by the player character against the enemy character is successful, and whether or not an attack launched by the enemy character against the player character is successful. A determination as to whether or not an attack has been successful can be made by determining the collision between characters. For example, a determination as to whether or not an attack launched by the enemy character has been successful can be made by determining whether or not the part of the arm used by the enemy character to attack the player character has collided with the player character, on the basis of information concerning the position of the player character, the position of the enemy character, etc. A determination as to whether or not an attack launched by the player character has been successful can be made by determining whether or not a weapon of the player character has collided with the enemy character, on the basis of information concerning the position of the player character, the position of the enemy character, etc.

The matching control unit 34 matches the game media (player characters) to each other. The game field is a virtual space of the game and is divided into a plurality of areas. The matching control unit 34 matches player characters within a predetermined area in the game field. For example, the matching control unit 34 acquires information concerning the location of each player character in the game field, and when a player character transfers from a certain area to an adjacent area (hereinafter, also referred to as an “adjacent area”), the player character is matched to the player character in the adjacent area, and the matching in that certain area is dissolved. The player can play the game jointly with another player matched to himself/herself through control of the player characters performed by the player character control unit 31. A joint play refers to, for example, fighting against a common enemy character or eating together.

The communication action control unit 40 decides one of a plurality of communication actions according to a game situation on the basis of an action-invoking input made by the player, and causes the game medium (player character) associated with the player to execute the decided communication action.

A communication action is an action for a player to communicate with another player via his/her game medium (player character) and includes a vocalization, a physical movement, or a combination thereof. A vocalization can include, for example, a greeting and a call. A physical movement can include, for example, a movement accompanying a greeting or a call, a movement such as so-called emoting related to an emotional expression, a gesture, a gesticulation, and a behavior. The combination of a vocalization and a physical movement can also include words and deeds. The communication actions here are situational communication actions described below.

An action-invoking input is an input for invoking a communication action and is made by the player via the input device 12. In an example, an action-invoking input is made by the player when he/she presses an action-invoking physical button provided on the game controller. In another example, an action-invoking input is made when an action-invoking button displayed on the touch panel is pressed by the player. In still another example, an action-invoking input is made when the player taps the touch pad that is the input device 12.

More specifically, the communication action control unit 40 decides, in response to an action-invoking input made by a first player, a first communication action on the basis of the game situation of a first game medium associated with the first player, and causes the first game medium to execute the first communication action. Then, the communication action control unit 40 decides a second communication action in response to an action-invoking input made by a second player after the execution of the first communication action, and causes a second game medium associated with the second player to execute the second communication action.

Here, the first game medium is a player character associated with the first player (hereinafter, also referred to as a “first player character”), and the second game medium is a player character associated with the second player (hereinafter, also referred to as a “second player character”). The first player and the second player are different players. The first communication action is a communication action executed by the first player character and is a situational communication action as described below. The first communication action is executed on a player character who is present within a predetermined range from the first player character and who is matched to the first player character. The second communication action is a communication action executed by the second player character and is a situational communication action described below. In an example, the second communication action is a communication action in response to the first communication action, and corresponds to the first communication action. In another example, the second communication action can be a communication action that is unrelated or less related to the first communication action.

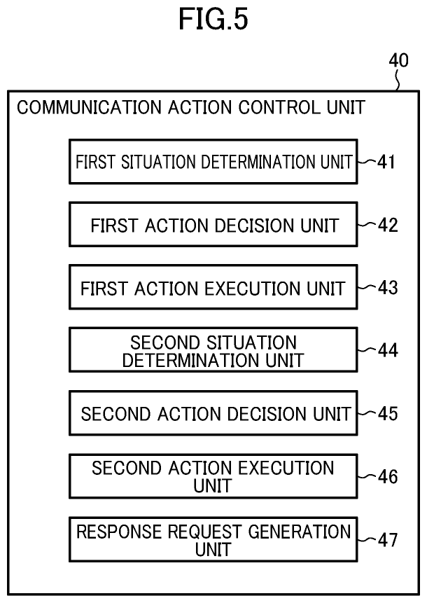

FIG. 5 is an example of a functional block diagram of the communication action control unit 40. As shown in FIG. 5, the communication action control unit 40 has a first situation determination unit 41, a first action decision unit 42, a first action execution unit 43, a second situation determination unit 44, a second action decision unit 45, a second action execution unit 46, and a response request generation unit 47.

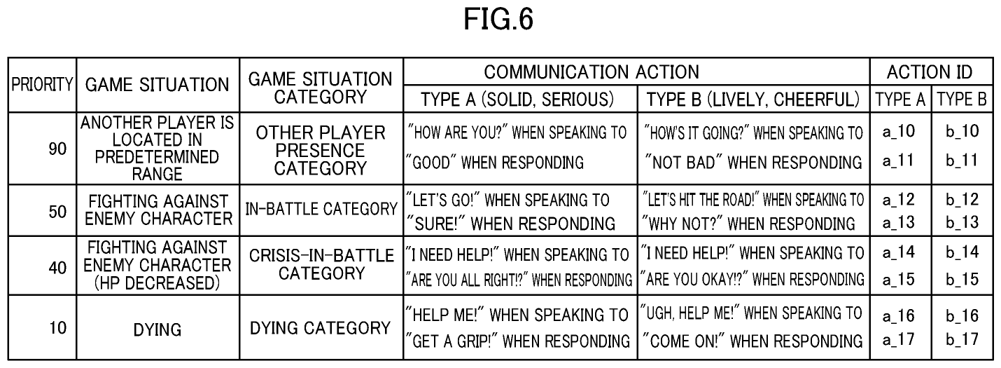

The first situation determination unit 41 identifies, in response to an action-invoking input made by the first player, a first game situation category on the basis of the game situation of the first player character. The game situation is a game situation of a player character and depends on information concerning the location of the player character in the game field, parameters such as the HP, information concerning the locations of the enemy character and other player characters, etc. The first game situation category is a game situation category of the first player character. Game situation categories are categories classified by game situation. As shown in FIG. 6, the game situation categories can include: an other player presence category indicating that another player character is present near the player character (in other words, within a predetermined range from the player character); an in-battle category indicating that the player character is fighting against an enemy character; a crisis-in-battle category indicating that the HP of the player character is not more than a first threshold value or not more than a first percentage of the HP while the player character is fighting against an enemy character; a dying category indicating that the HP of the player character is not more than a second threshold value, which is lower than the first threshold value, or not more than a second percentage, which is lower than the first percentage, of the HP; etc. In an example, in a game situation in which another player character is present within a predetermined range from the player character, the first situation determination unit 41 identifies the other player presence category as the first game situation category. The game situation categories are not limited to these categories, and can be set according to the game situation.

FIG. 6 is an example of a correspondence table between the game situation categories and communication actions. As shown in FIG. 6, communication actions are associated with each of the game situation categories. Note that the communication actions here are situational communication actions described below.

In this embodiment, the first situation determination unit 41 has a priority comparison decision unit 41a that, when a plurality of first game situation categories are identified, compares the priorities associated with the respective first game situation categories and decides the first game situation category with the highest priority. A priority is associated with each of the game situation categories. A priority can be expressed as a numerical value. For example, as shown in FIG. 6, the priorities of the other player presence category, the in-battle category, the crisis-in-battle category, and the dying category can be 90, 50, 40, and 10, with lower numerical values of priorities indicating higher priorities. In an example, in a game situation in which there is another player character within a predetermined range from the player character and the player character is fighting against an enemy character, the in-battle category, the crisis-in-battle category, and the dying category can be applicable as the first game situation category, and the priority comparison decision unit 41a compares the priorities of the identified plurality of game situation categories and decides that the game situation category with the highest priority is the first game situation category. The correspondence table may be set so that higher numerical values of priorities indicate higher priorities.

The first action decision unit 42 decides the first communication action associated with the first game situation category. The first communication action is a communication action to be executed by the first player character. Communication actions are associated with each of the game situation categories and stored in advance in the storage device 14. In this embodiment, a correspondence table between game situation categories and communication actions, in which game situation categories, priorities, and communication actions are associated with one another, is stored in the storage device 14, as shown in FIG. 6. In addition, a communication action of the player character who initiates a communication action and a communication action of a player character who responds to the initiated communication action are associated with each of the game situation categories. In the example shown in FIG. 6, the communication actions are vocalizations.

In the example shown in FIG. 6, as communication actions, audio data “How are you?” in the case where one player character speaks to another player character and audio data “Good” in the case where the other player character responds are associated with the other player presence category. Audio data “Let's go!” in the case where one player character speaks to another player character and audio data “Sure!” in the case where the other player character responds are associated with the in-battle category. Audio data “I need help!” in the case where one player character speaks to another player character and audio data “Are you all right !?” in the case where the other player character responds are associated with the crisis-in-battle category. Audio data “Help me!” in the case where one player character speaks to another player character and audio data “Get a grip!” in the case where the other player character responds are associated with the dying category.

In addition, a personality may be associated with a player character, so that communication actions can be set on the basis of the personality. In the example shown in FIG. 6, communication actions of Type A, which has a solid and serious personality, and communication actions of Type B, which has a lively and cheerful personality, are associated with each of the game situation categories in advance.

The first action decision unit 42 decides, as the first communication action, vocalization content of audio data when a player character speaks to another player character. More specifically, the first action decision unit 42 refers to the correspondence table in the storage device 14 and decides, on the basis of the identified first game situation category, the audio data that is used as the first communication action when a player character speaks to another player character. In the case where communication actions classified by personality type of the player character are associated with each of the game situation categories, this decision can be made according to the personality type of the first player character. In addition, the first action decision unit 42 may decide, as the first communication action, vocalization content of audio data used when a player character responds to another player character. That is, this first communication action is a communication action responding to the second communication action.

The first action execution unit 43 causes the first player character to execute the first communication action decided by the first action decision unit 42. For example, the first action execution unit 43 can play back the decided audio data and cause the speaker, which is the output device 13, of the information processing device 10 of another player to output the audio data, so that the other player can hear the vocalization content of the audio data. The output of audio data may be displayed on a display device, which is the output device 13, in the form of characters representing the vocalization content of the audio data.

The second situation determination unit 44 identifies, in response to an action-invoking input made by the second player, a second game situation category on the basis of the game situation of the second player character. The second game situation category is a game situation category of the second player character. The game situation is a game situation of a player character, similarly to above. Game situation categories are categories classified by game situation, similarly to above. The second situation determination unit 44 identifies a game situation category on the basis of the game situation in the same manner as the first situation determination unit 41. In other words, the first situation determination unit 41 and the second situation determination unit 44 differ only in the target player character, but otherwise execute the same processing. In an example, the second game situation category is the same as the first game situation category. For example, if the first and second player characters are in the same game situation, the first and second game situation categories are the same. In another example, the second game situation category is a different game situation category from the first game situation category. For example, the second game situation category can be different from the first game situation category in the case where there is not an enemy character near the first player character, there is an enemy character near the second player character, and the second player character is in crisis or dying.

The second situation determination unit 44 has a priority comparison decision unit 44a that, when a plurality of second game situation categories are identified, compares the priorities associated with the respective second game situation categories and decides the second game situation category with the highest priority. In an example, in a game situation in which there is another player character within a predetermined range from the player character, the other player presence category, the in-battle category, the crisis-in-battle category, and the dying category can be applicable as the second game situation category, and the priority comparison decision unit 44a compares the priorities of the identified plurality of game situation categories and decides that the game situation category with the highest priority is the second game situation category.

In the case where the second player character is located within a predetermined distance from the first player character in the game field of the game when the first player character executes the first communication action, the second situation determination unit 44 (or the communication action control unit 40) can determine that the first communication action is intended for the second player character. This second player character may be conditioned to be matched to the first player character.

In addition, in the case where an action-invoking input is made by the second player within a predetermined period of time from an action-invoking input made by the first player or the execution of the first communication action, the second situation determination unit 44 (or the communication action control unit 40) can determine that the first communication action is intended for the second player character. This second player character may be conditioned to be matched to the first player character.

The second action decision unit 45 decides the communication action associated with the second game situation category as the second communication action. The second communication action is a communication action executed by the second player character. More specifically, the second action decision unit 45 decides, as the second communication action, vocalization content of audio data that is associated with the second game situation category identified by the second situation determination unit 44 and that is used in response to a vocalization. In the case where communication actions classified by personality type of the player character are associated with each of the game situation categories, this decision can be made according to the personality type of the second player character.

The second action execution unit 46 causes the second player character to execute the second communication action decided by the second action decision unit 45. For example, the second action execution unit 46 can play back the decided audio data and cause the speaker, which is the output device 13, of the information processing device 10 of another player (e.g., first player) to output the audio data, so that the other player (e.g., first player) can hear the vocalization content of the audio data. The output of audio data may be displayed on a display device, which is the output device 13, in the form of characters representing the vocalization content of the audio data.

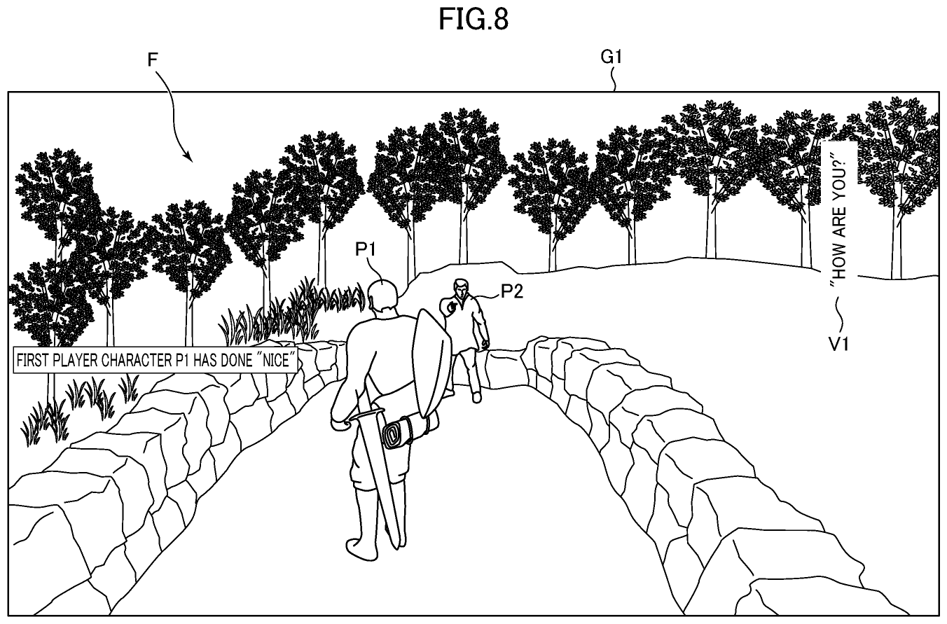

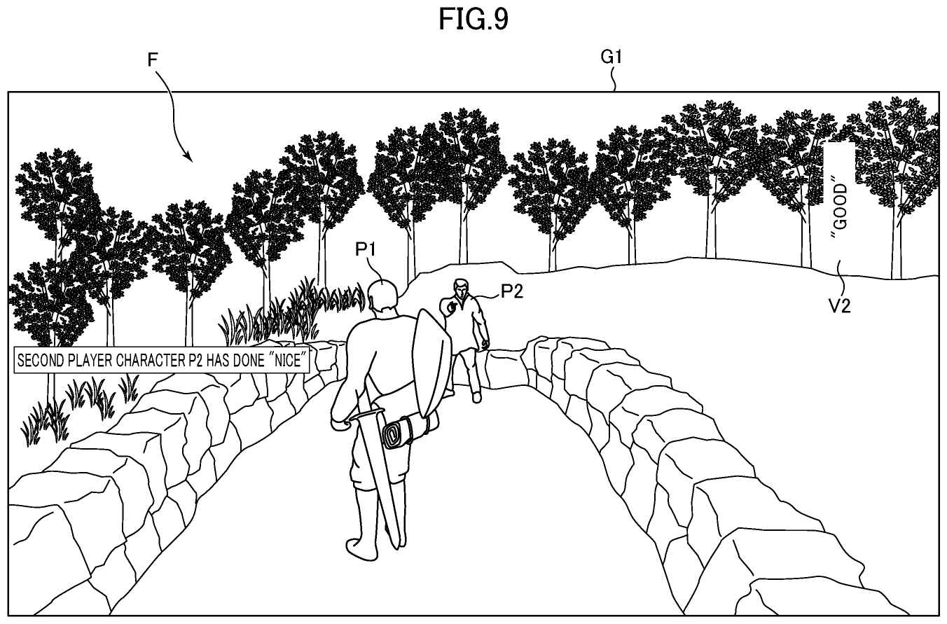

FIG. 8 is an example of the game screen showing execution of the first communication action, and FIG. 9 is an example of the game screen showing execution of the second communication action. As shown in FIGS. 8 and 9, on the bridge in a game field F, a second player character P2 is located within a predetermined range of a first player character P1, and conversely, the first player character P1 is located within a predetermined range of the second player character P2. In the example shown in FIG. 8, triggered by an action-invoking input made by the first player, the first action execution unit 43 executes the vocalization “How are you?” decided by the first action decision unit 42, and vocalization content V1 of the vocalization is output to the output device 13 (display unit, speaker) of the first player and to the output device 13 (display unit, speaker) of the second player. In the example shown in FIG. 9, triggered by an action-invoking input made by the second player who has heard this vocalization (vocalization content V1), the second action execution unit 46 executes the vocalization “Good” decided by the second action decision unit 45, and this vocalization content V2 is output to the output device 13 (display device, speaker) of the first player and to the output device 13 (display device, speaker) of the second player. This allows the first player and the second player to communicate through their respective player characters.

The response request generation unit 47 generates a response request. A response request is data requesting a second communication action corresponding to the first communication action decided by the first action decision unit 42. For example, a response request can include response-required information and communication action specification information.

Response-required information is information indicating that a response to the first communication action is required, and indicates that a response is required when it has a numerical value of, for example, 1. Note that response-required information can indicate that no responses are required when it has a numerical value of 0.

Communication action specification information is information that specifies a second communication action corresponding to the first communication action. As described above, a communication action executed by a player character who initiates an action and a communication action executed by another player character who responds to the initiated action are associated with each of the game situation categories, and an action ID is associated with each of the communication actions, as shown in FIG. 6. Action IDs can include numerical values, such as consecutive natural numbers for a player character who initiates an action and for a player character who responds to the initiated action. For example, of the consecutive natural numbers, even numbers can be made to correspond to the communication actions executed by the player character who initiates actions, and odd numbers can be made to correspond to the communication actions executed by a player character who responds to the initiated actions. In an example, if the action IDs of communication actions executed by the player character who initiates actions, i.e., first communication actions, include 10, then the action IDs of communication actions executed by the responding player character, i.e., second communication actions, may include 11. In this case, the communication action specification information is 11. In the example shown in FIG. 6, the action IDs also include a type-specific identifier (e.g., “a” for a_10).

More specifically, the response request generation unit 47 identifies the action ID of the communication action corresponding to the first communication action decided by the first action decision unit 42, and generates a response request including the action ID and response-required information. If the action ID of the decided first communication action is, for example, 10, then the response request generation unit 47 identifies, as 11, the action ID of the second communication action corresponding to the first communication action.

The response request generation unit 47 outputs the generated response request to the second action decision unit 45. The second action decision unit 45 decides a second communication action corresponding to the first communication action on the basis of a response request. In an example, in the case where the priority of the first game situation category and the priority of the second game situation category are the same, the second action decision unit 45 can make a decision on the basis of the response request. Note that in the case where the priorities of the first and second game situation categories are different, the second action decision unit 45 makes a decision based on the second game situation category, instead of making a decision based on the response request. The second action execution unit 46 causes the second player character to execute the second communication action decided on the basis of the response request. In another example, the second action decision unit 45 may determine whether or not the first game situation category and the second game situation category are same and, if the two categories are the same, may make a decision based on the response request. This allows discrimination between game situation categories that have the same priority but differ in category. Also in this case, the second action execution unit 46 causes the second player character to execute the second communication action decided on the basis of the response request. Note that, in the case where the first and second game situation categories are different, the second action decision unit 45 does not make a decision on the basis of the response request, but makes a decision on the basis of the second game situation category.

While a player character is executing an action, the communication action control unit 40 can cause the player character to execute a communication action of a different type from the action. The action here includes a normal action and a communication action. Normal actions are actions, other than communication actions, that are not intended for communication, such as a transfer, an attack, eating, etc., and are executed according to the progress of the game. Normal actions are assigned operations (inputs) that are different from the action-invoking inputs, such as an operation (input) for a transfer and an operation (input) for an attack. If these assigned operations (inputs) are called normal action-invoking inputs, then normal actions are actions that the player character control unit 31 causes the player character to execute in response to normal action-invoking inputs made by the player. As movements (motions) of the player character, dedicated movements, such as a movement for a transfer, a movement for an attack, etc., are also assigned.

The communication actions here are actions for communicating with other players, and more specifically, include selection communication actions and situational communication actions.

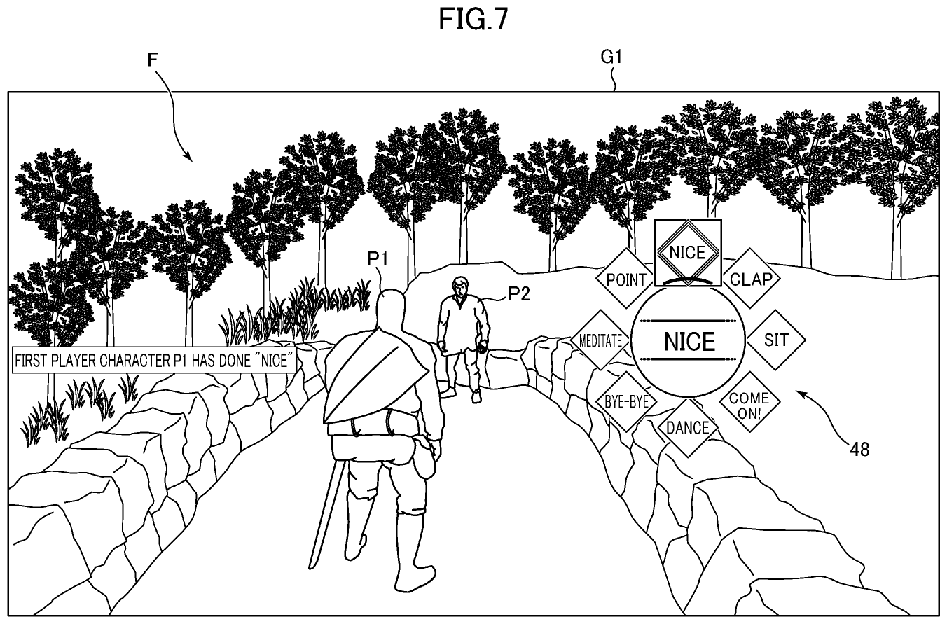

A selection communication action is a communication action requiring an action selection, as described below with reference to FIG. 7. In exchange for having to select one of a plurality of movements (may include a vocalization) by himself/herself, a player can communicate freely regardless of the game situation. A selection communication action is assigned a dedicated operation (input), via an action selection unit (more specifically, an action selection unit 48 described below), that differs from operations for normal actions and action-invoking inputs. For this reason, the player himself/herself needs to select a selection communication action to be executed. Selection communications are assigned different movements (e.g., physical movements) from each other.

A situational communication action is a communication action that is automatically decided according to the game situation in response to an action-invoking input as described above. A situational communication action is, for example, the first communication action and the second communication action. A situational communication action is assigned an action-invoking input that is different from the operations for normal actions and the operations executed by means of the action selection unit, and is automatically decided merely in response to an action-invoking input made by the player. For this reason, no situational communication actions need to be selected by the player. Situational communications are assigned different movements from each other. These movements do not include a selection communication action. In this embodiment, situational communication actions are mainly vocalizations but may include physical movements.

Any communication action of a different type from the action being executed is acceptable, as long as it does not interfere with the action of the player character being executed. A communication action of a different type from the action being executed can be (1) a situational communication action in the case where the action being executed is a normal action, (2) a situational communication action in the case where the action being executed is a selection communication action, and (3) a selection communication action in the case where the action being executed is a situational communication action.

In other words, a normal action and a selection communication action cannot be executed simultaneously, but a normal action and a situational communication action, as well as a selection communication action and a situational communication action, can be executed simultaneously. In this embodiment, normal actions and selection communication actions are player character movements (motions) while situational communication actions are vocalizations (voices), and therefore, the aforementioned combinations are possible. Even if situational communication actions are movements, simultaneous execution can be realized by motion combination. For example, the upper body part of the player character can execute the movement of a situational communication action (e.g., “nice” movement) while the lower body part execute the movement of a normal action (e.g., “transfer”). In this case, the communication action control unit 40 and the player character control unit 31 work together to combine motions in response to an action-invoking input and a normal action-invoking input.

Note that a selection communication action and a situational communication action may include the same movement assigned thereto. For example, vocalizations and physical movements may be included not only in situational communication actions but also in selection communication actions. A selection communication action and a situational communication action can be executed to the extent that they do not interfere with the action of the player character being executed.

FIG. 7 is an example of a game screen showing an action selection made by the player. As shown in FIG. 7, in the case where the second player character P2 is located within a predetermined range of the first player character P1, the communication action control unit 40 displays the action selection unit 48 on a game screen G1. The action selection unit 48 accepts the selection of one of a plurality of actions to be executed by the player character. In the example shown in FIG. 7, the action selection unit 48 that allows the first player to select an action of the first player character P1 is displayed on the output device 13 (display device) of the first player. In the action selection unit 48, actions such as “nice”, “clap”, “sit”, “come on!”, “dance”, “bye-bye”, “meditate”, and “point” are presented. In the example shown in FIG. 7, the “nice” action is selected by the first player, and the first player character P1 executes the action, accordingly. The “nice” action is a thumbs-up gesture. As shown in FIG. 8, when the first player selects the action selection unit 48 and makes an action-invoking input after the selection, the first player character is made to concurrently execute the “nice” action and the first communication action “How are you?”. Thereafter, as shown in FIG. 9, when the second player selects the action selection unit 48 and makes an action-invoking input, the second player can be made to concurrently execute the “nice” action and the second communication action “Good”.

In response to an input made by the second player within a predetermined period of time after the first communication action of the first player character is executed, the display control unit 50 highlights the first communication action on the game screen. The predetermined period of time can be, for example, several seconds, but can be set by the game developer as appropriate. This input made by the second player is an input via the input device 12 of the information processing device 10 of the second player and is a dedicated operation different from an action-invoking input that invokes a communication action.

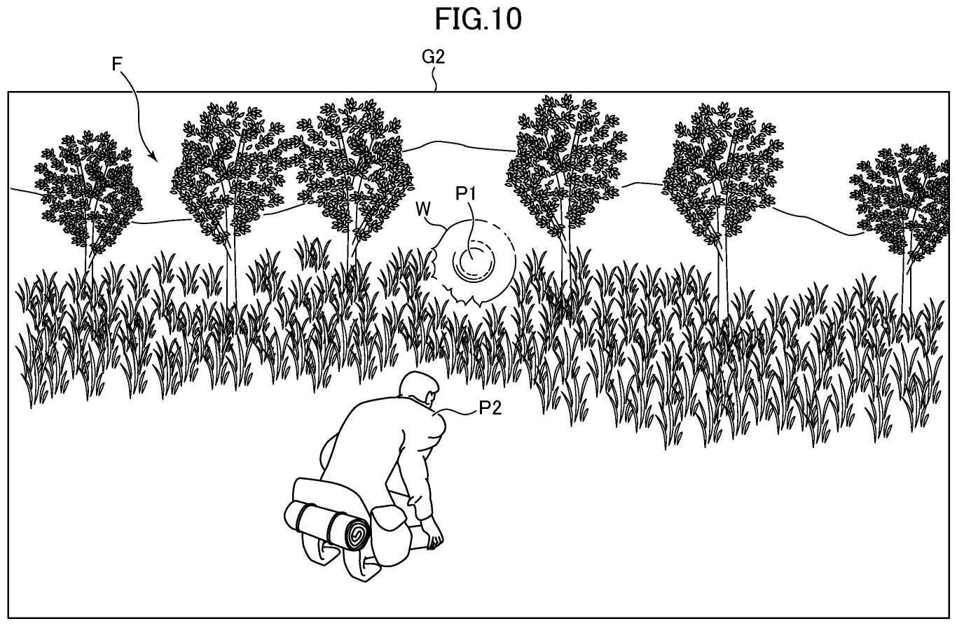

FIG. 10 is an example of a game screen displayed in highlights by the display control unit 50. A game screen G2 in FIG. 10 is a game screen to be displayed on the output device 13 (display device) of the second player, and the first player character P1 and the second player character P2 are displayed in the game field F with respect to the second player character P2. In the example shown in FIG. 10, the first communication action (vocalization in this case) highlighted on the game screen G2 is highlighted as a ripple W centered on the first player character P1. The highlighted display of the communication action is not limited to the ripple W, but can be any prominent indication that the player notices, such as changing the display color or blinking of the player character. This highlighted display allows the second player to know the location of the first player character even in a situation in which the second player hears a voice but does not know the location of the first player character. For example, the second player character can go to help the first player character.

### [Operation]

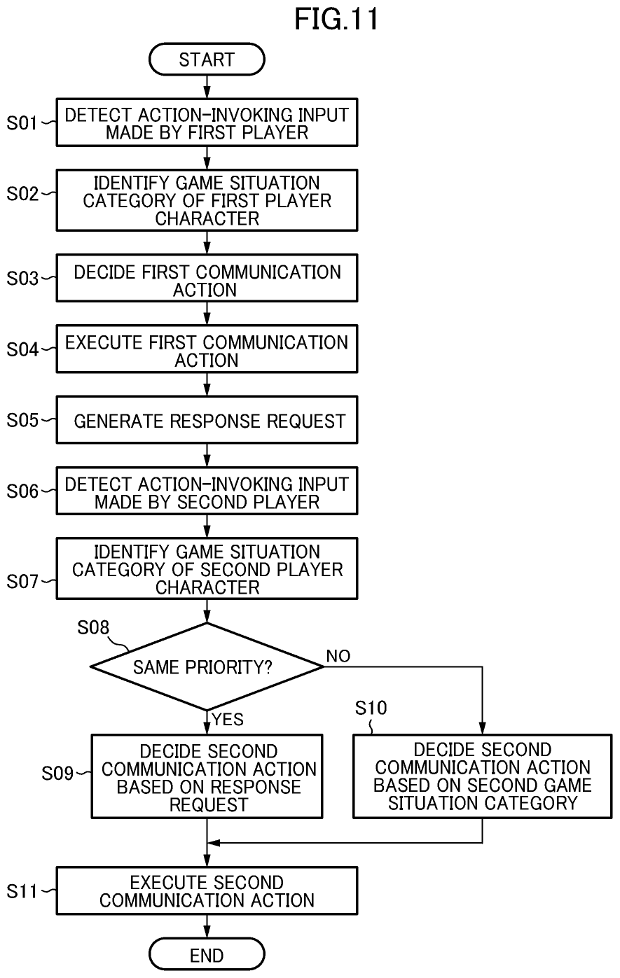

The operation of the game system 1 according to an embodiment of the present invention will now be described. FIG. 11 is an example of an operation flowchart for the game system 1 according to an embodiment of the present invention. It is assumed that communication actions are vocalizations in describing the operation flow.

As shown in FIG. 11, when an action-invoking button is pressed by the first player via the input device 12 of the first player, the communication action control unit 40 detects an action-invoking input (S01: Detect action-invoking input made by first player). When this action-invoking input is detected, the first game situation category is identified by the first situation determination unit 41 on the basis of the game situation of the first player character (S02: Identify game situation category of first player character). If the game situation falls under a plurality of game situation categories, the game situation category with the highest priority is identified as the first game situation category by the priority comparison decision unit 41a.

When the first game situation category is identified, a first communication action associated with the identified first game situation category is decided by the first action decision unit 42 (S03: Decide first communication action). More specifically, the first action decision unit 42 refers to the correspondence table stored in the storage device 14, identifies audio data on the basis of the first game situation category and the personality type of the first player character, and decides the vocalization content of the audio data as the first communication action.

Once the first communication action is decided, the first action execution unit 43 causes the first player character to execute the decided first communication action (S04: Execute first communication action). This execution causes the output device 13 including the display device and the speaker of the first player to execute an output operation, and also causes the output device 13 including the display device and the speaker of another player matched to the first player to execute an output operation. This allows the other player to know that a communication action has been taken by the first player. The other player can be at least one player whose player character to be manipulated is located within a predetermined range from the first player character in the game field.

Next, a response request is generated by the response request generation unit 47 (S05: Generate response request). The response request includes response-required information, which indicates that a response to the first communication action is required, and communication action specification information, which specifies the second communication action corresponding to the first communication action. The generated response request is output by the response request generation unit 47 to the second action decision unit 45.

After the output of the first communication action, when an action-invoking button is pressed by the second player, who is one of the at least one other player having received the output, via the input device 12 of the second player, the communication action control unit 40 detects an action-invoking input made by the second player (S06: Detect action-invoking input made by second player). If the action-invoking input has been made by the second player within a predetermined period of time after the action-invoking input made by the first player or the execution of the first communication action, the second situation determination unit 44 can determine that the first communication action is intended for the second player character. Alternatively, if the action-invoking input has been made by the second player after the predetermined period of time, the second situation determination unit 44 can determine that the first communication action is not intended for the second player character. Here, it is assumed that the action-invoking input has been made by the second player within the predetermined time.

When this action-invoking input is detected, the second game situation category is identified by the second situation determination unit 44 on the basis of the game situation of the second player character (S07: Identify game situation category of second player character). If the game situation falls under a plurality of game situation categories, the game situation category with the highest priority is identified as the second game situation category by the priority comparison decision unit 44a.

When the second game situation category is identified, the second action decision unit 45 determines whether or not the priority of the first game situation category identified in S02 and the priority of the second game situation category identified in S07 are the same (S08: Same priority?). If the priorities are the same (YES in S08), the second action decision unit 45 decides the second communication action on the basis of the response request (S09: Decide second communication action on the basis of response request). More specifically, the second action decision unit 45 identifies audio data on the basis of the communication action specification information included in the response request, the correspondence table in FIG. 6, and the personality type of the second player character and decides the vocalization content of the audio data as the second communication action. On the other hand, if the priorities are different (NO in S08), the second action decision unit 45 refers to the correspondence table in FIG. 6 and decides that the communication action associated with the second game situation category identified in S07 is the second communication action (S10: Decide second communication action on the basis of second game situation category). More specifically, the second action decision unit 45 identifies audio data on the basis of the second game situation category and the personality type of the second player character and decides the vocalization content of the audio data as the second communication action.

Once the second communication action is decided, the second action execution unit 46 causes the second player character to execute the decided second communication action (S11: Execute second communication action). This execution causes the output device 13 including the display device and the speaker of the second player to output the second communication action and also causes the output device 13 including the display device and the speaker of the first player to output the second communication action. This allows the first player to understand the communication action from the second player.

Note that, in step S02, if a predetermined period of time or more has elapsed since an action-invoking input that is made by another player before the action-invoking input made by the first player, the first situation determination unit 41 can determine that the action-invoking input made by the first player is an input to initiate communication.

As described above, the first communication action is automatically decided and executed when the first player makes an action-invoking input, and the second communication action is then automatically decided and executed when the second player makes an action-invoking input. Therefore, players do not need to determine a game situation or select a communication action and are thus allowed to casually interact with each other.

In the aforementioned example, the generation and output of a response request are executed in S05, but it suffices if these processes are executed after step S03, where the first communication action is decided, and before step S09 or S10, where the second communication action is decided. Also, here, it is determined in S08 whether or not the priorities are the same, but instead of priorities, the second action decision unit 45 may determine whether or not the first game situation category and the second game situation category are the same category.

The determination in S08 as to whether or not the priorities or categories are the same may be made by the second situation determination unit 44, instead of the second action decision unit 45.

### Operations and Advantages

(1) The game system 1 according to this embodiment is a system for a game and has a plurality of information processing devices 10, wherein at least one of the information processing devices 10 includes the communication action control unit 40 for deciding a communication action among a plurality of communication actions according to a game situation in response to an action-invoking input made by a player and causing a game medium associated with the player to execute the decided communication action, and the communication action control unit 40 decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

This allows the players to casually interact with each other since they do not have to determine a game situation or select a communication action by themselves.
(2) The communication action control unit 40 has: the first situation determination unit 41 for identifying a first game situation category on the basis of the game situation of the first game medium in response to the action-invoking input made by the first player; the first action decision unit 42 for deciding a first communication action associated with the first game situation category; the first action execution unit 43 for causing the first game medium to execute the first communication action; the second situation determination unit 44 for identifying a second game situation category on the basis of a game situation of the second game medium in response to the action-invoking input made by the second player; the second action decision unit 45 for deciding that a communication action associated with the second game situation category is the second communication action; and the second action execution unit 46 for causing the second game medium to execute the second communication action.

This allows communication actions to be executed according to the respective game situations of the first and second game media, so that communication according to the situation of each of the game media is possible. In an example, if the first game situation category and the second game situation category are the same, then the second communication action corresponding to the first communication action can be executed for communication, such as responding to a greeting with a greeting. In another example, if the first game situation category and the second game situation category are different, the second communication action does not necessarily correspond to the first communication action because the game situations of the game media are different, possibly leading to a discrepancy in communication. Nonetheless, the first player can understand the situation of the second player (second game medium) from the second communication action. In the case where, for example, the first game medium is in a normal game situation while the second game medium is in a dying game situation, when the first player causes the first game medium to execute a greeting to the second game medium as the first communication action, the second game medium can produce a sound such as “Ugh, help me . . . !”, etc., as the second communication action, allowing the first player to take the next action after knowing that the second game medium is in a dying state.
(3) The first situation determination unit 41 has the priority comparison decision unit 41a for, in the case where a plurality of the first game situation categories are identified, comparing priorities associated with the first game situation categories and deciding the first game situation category with the highest priority, the first action decision unit 42 decides the first communication action associated with the first game situation category with the highest priority, the second situation determination unit 44 has the priority comparison decision unit 44a for, in the case where a plurality of the second game situation categories are identified, comparing priorities associated with the second game situation categories and deciding the second game situation category with the highest priority, and the second action decision unit 45 decides the second communication action associated with the second game situation category with the highest priority.

This allows the first and second game media to execute communication actions that are best suited to their respective game situations.
(4) The communication action control unit 40 has the response request generation unit 47 for generating a response request that requests the second communication action corresponding to the first communication action decided by the first action decision unit 42, the second action decision unit 45 decides the second communication action corresponding to the first communication action on the basis of the response request, and the second action execution unit 46 causes the second game medium to execute the second communication action decided on the basis of the response request.

This enables natural communication between the first and second players.
(5) The at least one information processing device 10 further includes the matching control unit 34 for matching the game media in a predetermined area in a game field of the game, wherein the first communication action is executed upon the game medium that is matched to the first game medium and that is present in a predetermined range from the first game medium, and the communication action control unit 40 decides that the first communication action is intended for the second game medium in the case where the second game medium is located within a predetermined distance from the first game medium in the game field of the game when the first game medium executes the first communication action.

This makes it possible to determine that there is a communication relationship between the first and second game media in the information processing system 10, allowing the player to casually interact with another player he/she happens to encounter in the predetermined area. In particular, the game medium that receives the first communication action from the first game medium can be a game medium that is visible via the game screen to the first player associated with the first game medium. In this case, the player associated with the game medium can also see, via the game screen, the first player associated with the first game medium. Thus, natural communication can be achieved between players who can see each other's game medium.
(6) The communication action control unit 40 decides that the first communication action is intended for the second game medium in the case where the action-invoking input made by the second player occurs within a predetermined period of time from the action-invoking input made by the first player or the execution of the first communication action.

This makes it possible to determine that there is a communicating relationship between the first and second game media in the information processing system 10.
(7) The first communication action may be a communication action responding to the second communication action. This allows players to realize continuous responses therebetween simply by making an action-invoking input, allowing the players to casually interact with each other. For example, a situation can be realized in which the first game medium speaks to the second game medium→the second game medium responds→the first game medium further responds . . . . More specifically, such a situation can be realized with a configuration, for example, wherein “in the case where another action-invoking input is made by the first player within a predetermined period of time from the action-invoking input made by the second player or the execution of the second communication action, the first situation determination unit 41 determines that the second communication action is intended for the first game medium, and the first action decision unit 42 decides a first communication action that is associated with the game situation category identified by the first situation determination unit 41 and that responds to the second communication action”.

Although the aforementioned embodiment has been described by way of an example where a pair of communication actions are associated with one game situation category in the correspondence table between game situation categories and communication actions, a plurality of pairs of communication actions may be associated with one game situation category, such as a series of communication actions in which the first game medium speaks to the second game medium→the second game medium responds→the first game medium further responds→the second game medium further responds.
(8) While executing an action, the game medium (player character) can execute a communication action of a different type from that of the action. This allows players to communicate with each other while manipulating the game media, allowing the players to casually interact with each other.
(10) The at least one information processing device 10 includes the display control unit 50 for displaying in highlights the first communication action of the first game medium on a game screen on the basis of an input made by the second player within a predetermined period of time after the execution of the first communication action.

This allows the second player to know the location of the first game medium that has executed the first communication action, making it easier to respond to the communication action, i.e., execute the second communication action, leading to a casual interaction with other players.

### [Embodiment Realized by Information Processing Device]

Although the aforementioned embodiment has been described by way of an example where the game control unit 25 including the communication action control unit 40 is included in the server 10A, the game control unit 25 may be included in the terminal device 10B of each player. In this case, inputs, including an action-invoking input, made by each player, as well as other information and data necessary for game processing, are transmitted to the terminal devices 10B of other players via the communication device 15, and the same game processing is executed on each of the terminal devices 10B.

### Other Embodiments

The first situation determination unit 41, the first action decision unit 42, and the first action execution unit 43 may be included in the terminal device 10B of the first player, and the second situation determination unit 44, the second action decision unit 45, and the second action execution unit 46 may be included in the terminal device 10B of the second player. The response request generation unit 47 may be included in the terminal device 10B of the first player or the terminal device 10B of the second player. Also in these cases, data and information necessary for game processing can still be obtained via the communication device 15.

In another example, the server 10A is a web server and provides game services to the terminal devices 10B. Each of the terminal devices 10B obtains, from the server 10A, HTML data for displaying a web page and analyzes the obtained HTML data to display the web page. In this case, the server 10A communicating with the terminal device 10B has all or some of the functions of the game control unit 25.

Although the aforementioned embodiment has been described by way of an example where an action-invoking input is made by pressing an action-invoking button of the input device 12, an action-invoking input may be made by speaking to the input device 12, such as the microphone or the like, with a predetermined word, instead of pressing the button. This also allows a player to communicate with other players with a single operation.

In the aforementioned embodiment, depending on the game situations of the player characters, the first game situation category and the second game situation category may have different priorities. In this case, in the aforementioned embodiment, it is possible that the second communication action, although it is a communication action executed by a responding player character, does not correspond to the first communication action because the game situation categories are different. Therefore, the second action decision unit 45, instead of deciding that the communication action of the responding player character is the second communication action as in the aforementioned embodiment, may decide that the communication action that is associated with the second game situation category and that is executed by the player character who initiates communication is the second communication action. For example, if the second game situation category has a higher priority than the first game situation category, this decision may give priority to the second player's position in the communication. In this case, the response request generation unit 47 may request a first communication action that corresponds to the second communication action and that is executed by the responding player character.

Another embodiment of the present invention may be a program for realizing the functions or the information processing shown in the flowchart in the aforementioned embodiment of the present invention, or a computer-readable storage medium storing the program. Still another embodiment of the present invention may be a method for realizing the functions or the information processing shown in the flowchart in the aforementioned embodiment of the present invention. Still another embodiment of the present invention may be a server that is capable of providing a computer with a program for realizing the functions or the information processing shown in the flowchart in the aforementioned embodiment of the present invention. Still another embodiment of the present invention may be a virtual machine for realizing the functions or the information processing shown in the flowchart in the aforementioned embodiment of the present invention.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 Game system
10 Information processing device
10A Server
10B Terminal device
11 Processor
12 Input device
13 Output device
14 Storage device
15 Communication device
16 Bus
21 Input unit
22 Output unit

1. A non-transitory computer readable medium storing a program for a game executed on an information processing device, said program causing the information processing device to function as:
communication action control means for deciding a communication action among a plurality of communication actions according to a game situation in response to an action-invoking input made by a player and causing a game medium associated with the player to execute the decided communication action,
wherein the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

2. The non-transitory computer readable medium according to claim 1,
wherein the communication action control means has:
first situation determination means for identifying a first game situation category on the basis of the game situation of the first game medium in response to the action-invoking input made by the first player;
first action decision means for deciding a first communication action associated with the first game situation category;
first action execution means for causing the first game medium to execute the first communication action;
second situation determination means for identifying a second game situation category on the basis of a game situation of the second game medium in response to the action-invoking input made by the second player;
second action decision means for deciding that a communication action associated with the second game situation category is the second communication action; and
second action execution means for causing the second game medium to execute the second communication action.

3. The non-transitory computer readable medium according to claim 2,
wherein the first situation determination means has priority comparison decision means for, in the case where a plurality of the first game situation categories are identified, comparing priorities associated with the first game situation categories and deciding the first game situation category with the highest priority,
the first action decision means decides the first communication action associated with the first game situation category with the highest priority,
the second situation determination means has priority comparison decision means for, in the case where a plurality of the second game situation categories are identified, comparing priorities associated with the second game situation categories and deciding the second game situation category with the highest priority, and
the second action decision means decides the second communication action associated with the second game situation category with the highest priority.

4. The non-transitory computer readable medium according to claim 2,
wherein the communication action control means has response request generation means for generating a response request that requests the second communication action corresponding to the first communication action decided by the first action decision means,
the second action decision means decides the second communication action corresponding to the first communication action on the basis of the response request, and
the second action execution means causes the second game medium to execute the second communication action decided on the basis of the response request.

5. The non-transitory computer readable medium according to claim 1,
causing the information processing device to further function as:
matching control means for matching the game media in a predetermined area in a game field of the game,
wherein the first communication action is executed upon the game medium that is matched to the first game medium and that is present in a predetermined range from the first game medium, and
the communication action control means decides that the first communication action is intended for the second game medium in the case where the second game medium is located within a predetermined distance from the first game medium in the game field of the game when the first game medium executes the first communication action.

6. The non-transitory computer readable medium according to claim 1,
wherein the communication action control means decides that the first communication action is intended for the second game medium in the case where the action-invoking input made by the second player occurs within a predetermined period of time from the action-invoking input made by the first player or the execution of the first communication action.

7. The non-transitory computer readable medium according to claim 1,
wherein the first communication action is a communication action responding to the second communication action.

8. The non-transitory computer readable medium according to claim 1,
wherein the first communication action or the second communication action includes a vocalization, a physical movement, or a combination thereof.

9. The non-transitory computer readable medium according to claim 1,
wherein, while executing an action, the game medium can execute the communication action of a different type from that of the action.

10. The non-transitory computer readable medium according to claim 1,
causing the information processing device to further function as:
display control means for displaying in highlights the first communication action of the first game medium on a game screen on the basis of an input made by the second player within a predetermined period of time after the execution of the first communication action.

11. An information processing device for executing a game, said information processing device comprising:
communication action control means for deciding a communication action among a plurality of communication actions according to a game situation in response to an action-invoking input made by a player and causing a game medium associated with the player to execute the decided communication action,
wherein the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.

12. A method for a game, said method comprising:
a communication action control step for deciding a communication action among a plurality of communication actions according to a game situation in response to an action-invoking input made by a player and causing a game medium associated with the player to execute the decided communication action,
wherein, in the communication action control step, a first communication action is decided on the basis of a game situation of a first game medium associated with a first player in response to an action-invoking input made by the first player, the first game medium is made to execute the first communication action, a second communication action is decided in response to an action-invoking input made by a second player after the execution of the first communication action, and a second game medium associated with the second player is made to execute the second communication action.

13. A system for a game, said system having a plurality of information processing devices,
wherein at least one of the information processing devices comprises communication action control means for deciding a communication action among a plurality of communication actions according to a game situation in response to an action-invoking input made by a player and causing a game medium associated with the player to execute the decided communication action, and
the communication action control means decides a first communication action on the basis of a game situation of a first game medium associated with a first player in response to an action-invoking input made by the first player, causes the first game medium to execute the first communication action, decides a second communication action in response to an action-invoking input made by a second player after the execution of the first communication action, and causes a second game medium associated with the second player to execute the second communication action.
